(19) United States
(12) Patent Application Publication
(10) Pub. No.: US 2023/0082895 A1
(43) Pub. Date: Mar. 16, 2023

(54) OPTICAL DEVICE PROVIDED WITH A PLURALITY OF LENSES

(71) Applicant: Fujitsu Optical Components Limited, Kawasaki-shi (JP)

(72) Inventor: Takeshi Matsumoto, Ebina (JP)

(73) Assignee: Fujitsu Optical Components Limited, Kawasaki-shi (JP)

(21) Appl. No.: 17/882,992

(22) Filed: Aug. 8, 2022

(30) Foreign Application Priority Data
Sep. 13, 2021 (JP) 2021-148927

(51) Int. Cl. G02B 6/42

(52) U.S. Cl. CPC G02B 6/4206; G02B 6/4244

(57) ABSTRACT

Optical device, that is provided between optical output element and optical propagation element, includes: first lens circuit configured to include one or more lenses through which output light of the optical output element passes; and second lens circuit configured to include one or more lenses and guide output light of the first lens circuit to the optical propagation element. When F11 represents distance between the optical output element and the first lens circuit, F12 represents distance between the first lens circuit and first beam waist position of the first lens circuit, F21 represents distance between the first beam waist position and the second lens circuit, and F22 represents distance between the second lens circuit and second beam waist position of the second lens circuit, F11 and F22 are equal to each other and F12 and F21 are equal to each other.

### CROSS-REFERENCE TO RELATED APPLICATION

This application is based upon and claims the benefit of priority of the prior Japanese Patent Application No. 2021-148927, filed on Sep. 13, 2021, the entire contents of which are incorporated herein by reference.

### FIELD

The embodiments discussed herein are related to an optical device provided with a plurality of lenses.

### BACKGROUND

In many cases, an optical communication module is provided with an optical device for guiding output light of a laser light source to an optical fiber or an optical waveguide. A small optical loss is required for such an optical device.

FIG. 1 illustrates an example of an optical device for guiding output light of a laser light source to an optical fiber. In this example, an optical device 100 is provided with a ball lens 101 and a ball lens 102. The ball lenses 101 and 102 are respectively installed in grooves formed in a surface of a substrate 110. In addition, a semiconductor laser light source (LD) 111 is mounted on the surface of the substrate 110. Further, an end of an optical fiber 112 is arranged in an edge of the substrate 110.

The output light of the semiconductor laser light source 111 is guided to the ball lens 101. Output light of the ball lens 101 is guided to the ball lens 102. Output light of the ball lens 102 is guided to the optical fiber 112. Herein, the optical device 100 is designed so as to satisfy the following requirements.

(1) The ball lens 101 collimates the output light of the semiconductor laser light source 111. In other words, collimated light propagates from the ball lens 101 to the ball lens 102.
(2) The ball lens 102 condenses the collimated light output from the ball lens 101 into the end face of the optical fiber 112.

By this configuration, the semiconductor laser light source 111 is optically coupled to the optical fiber 112.

In addition, proposed is an optical module provided with a semiconductor laser, a first ball lens to collimate emitted light from the semiconductor laser, and a second ball lens to optically couple the collimated light to an optical fiber (e.g., Japanese Laid-open Patent Publication No. 2002-341189).

In the configuration illustrated in FIG. 1, when positions of the ball lenses 101 and/or 102 are displaced with respect to the optical axis, a point into which the output light of the ball lens 102 is condensed shifts from a target position. For example, when a depth of the groove formed on the surface of the substrate 110 deviates from a target value due to a manufacturing error, the point into which the output light of the ball lens 102 is condensed shifts from the center of an end face of the optical fiber 112. In this case, optical losses are increased, and there is the risk that quality of optical communication is poor. This problem is resolved or relieved by aligning the optical fiber 112 corresponding to the manufacturing error. However, when aligning of the optical fiber 112 is performed, productivity of the optical module is decreased.

In addition, in the case where the optical device 100 illustrated in FIG. 1 guides output light of the semiconductor laser light source 111 to an optical waveguide, it is not possible to perform aligning. In this case, when the positions of the ball lenses 101 and/or 102 are displaced with respect to the optical axis, it is difficult to suppress the optical loss.

### SUMMARY

According to an aspect of the embodiments, an optical device provided between an optical output element and an optical propagation element, the optical device includes: a first lens circuit configured to include one or more lenses through which output light of the optical output element passes; and a second lens circuit configured to include one or more lenses and guide output light of the first lens circuit to the optical propagation element. When F11 represents a distance between the optical output element and the first lens circuit, F12 represents a distance between the first lens circuit and a first beam waist position indicative of a point at which the output light of the optical output element is condensed by the first lens circuit, F21 represents a distance between the first beam waist position and the second lens circuit, and F22 represents a distance between the second lens circuit and a second beam waist position indicative of a point at which the output light of the first lens circuit is condensed by the second lens circuit, F11 and F22 are equal to each other and F12 and F21 are equal to each other.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of an optical device for guiding output light of a laser light source to an optical fiber;

FIGS. 2A and 2B are diagrams to explain an object focal distance and an image focal distance according to an embodiment of the present invention;

FIG. 3 illustrates an example of an optical device according to the embodiment of the present invention;

FIGS. 4A and 4B illustrate a first embodiment of the optical device according to the present invention;

FIGS. 5A and 5B are diagrams to explain definitions of a focal distance of a lens;

FIGS. 6A and 6B are diagrams to explain definitions of the object focal distance and image focal distance;

FIGS. 7A and 7B are diagrams to explain an effect by position displacement of a lens;

FIGS. 8A and 8B are diagrams to explain a reason why the effect by position displacements of ball lenses is suppressed;

FIGS. 9A and 9B illustrate an example of propagation of laser light from the light source to an optical waveguide;

FIG. 10 illustrates an example of an effect by a configuration according to the first embodiment;

FIGS. 11A and 11B illustrate a second embodiment of the optical device according to the present invention;

FIG. 12 illustrates an example of an effect by configuration according to the second embodiment;

FIG. 13 illustrates a third embodiment of the optical device according to the present invention; and

FIG. 14 illustrates a fourth embodiment of the optical device according to the present invention.

### DESCRIPTION OF EMBODIMENTS

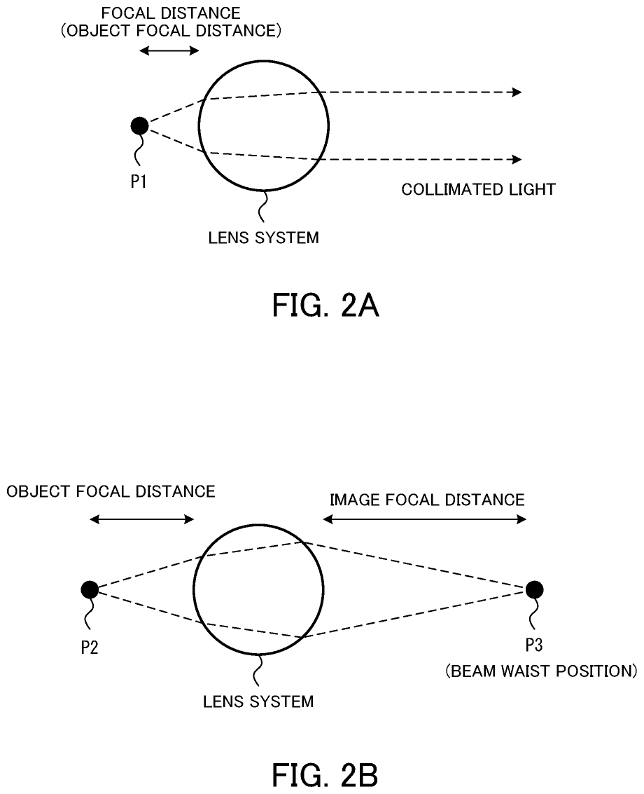

FIGS. 2A and 2B are diagrams to explain an object focal distance and an image focal distance according to an embodiment of the present invention. Note that, in FIGS. 2A and 2B, a lens system is provided with one or a plurality of lenses.

In the case illustrated in FIG. 2A, light emitted from a point P1 is collimated by the lens system. In this case, a distance between the point P1 and the lens system is called a focal distance.

In the case illustrated in FIG. 2B, light is emitted from a point P2. Herein, a distance between the point P2 and the lens system is shorter than the distance between the point P1 and the lens system illustrated in FIG. 2A, and the light emitted from the lens system is condensed at a point P3. In this case, in the following description, the distance between the lens system and the point P3 may be called an image focal distance. In other words, when incident light to the lens system is condensed by the lens system, the image focal distance indicates a distance between the lens system and the condensed point. In addition, when the incident light to the lens system is condensed by the lens system, the condensed point (i.e., point where a mode field diameter of the light is minimized) may be called a beam waist position. In this case, when the incident light to the lens system is condensed by the lens system, the image focal distance indicates a distance between the lens system and the beam waist position.

The object focal distance indicates a distance between an emission point of light and the lens system. For example, in the case illustrated in FIG. 2B, a distance between the point P2 and the lens system corresponds to the object focal distance. In the case illustrated in FIG. 2A, the distance between the point P1 and the lens system corresponds to the object focal distance. Note that, in the case illustrated in FIG. 2A, the object focal distance is the same as the focal distance.

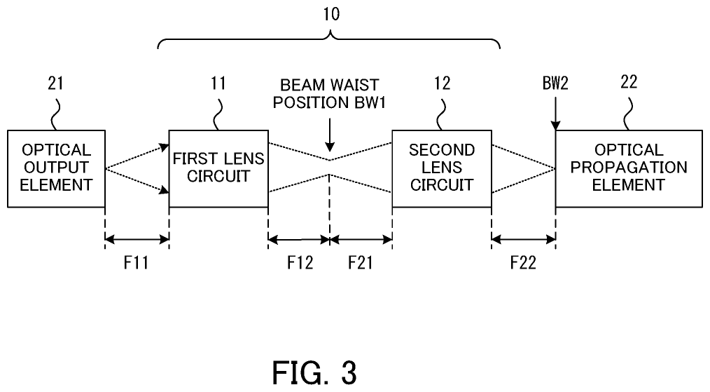

FIG. 3 illustrates an example of an optical device according to the embodiment of the present invention. An optical device 10 according to the embodiment of the invention is provided between an optical output element 21 and an optical propagation element 22. For example, the optical output element 21 is a laser light source for generating laser light. However, the optical output element 21 is not limited to the laser light source, and may be an optical waveguide or optical fiber. For example, the optical propagation element 22 is actualized by the optical waveguide or optical fiber.

The optical device 10 is provided with a first lens circuit 11 and a second lens circuit 12. The first lens circuit 11 includes one or a plurality of lenses, and guides output light of the optical output element 21 to the second lens circuit 12. The second lens circuit 12 includes one or a plurality of lenses, and guides output light of the first lens circuit 11 to the optical propagation element 22. In other words, the output light of the optical output element 21 is guided to the optical propagation element 22 by the first lens circuit 11 and the second lens circuit 12.

The optical device 10 is configured so as to satisfy “F11=F22” and “F12=F21”. F11 represents an object focal distance of the first lens circuit 11. Specifically, the object focal distance F11 indicates a distance between the optical output element 21 and the first lens circuit 11. F12 represents an image focal distance of the first lens circuit 11. Specifically, the image focal distance F12 indicates a distance between the first lens circuit 11 and a beam waist position BW1 indicative of a point in which the output light of the optical output element 21 is condensed by the first lens circuit 11. As explained with reference to FIG. 2B, the beam waist position indicates the position at which the mode field diameter of output light of the lens system is minimized.

Laser light output from the first lens circuit 11 is condensed in the beam waist position BW1, and then, is input to the second lens circuit 12, while enlarging the mode field diameter. Accordingly, in the case where the second lens circuit 12 is the lens system illustrated in FIG. 2B, the beam waist position BW1 corresponds to the point P2. A distance between the beam waist position BW1 and the second lens circuit 12 indicates an object focal distance F21 of the second lens circuit 12. Note that a distance between the first lens circuit 11 and the second lens circuit 12 is F12+F21. F22 represents an image focal distance of the second lens circuit 12. Specifically, the image focal distance F22 indicates a distance between the second lens circuit 12 and a beam waist position BW2 indicative of a point at which the output light of the first lens circuit 11 is condensed by the second lens circuit 12.

### First Embodiment

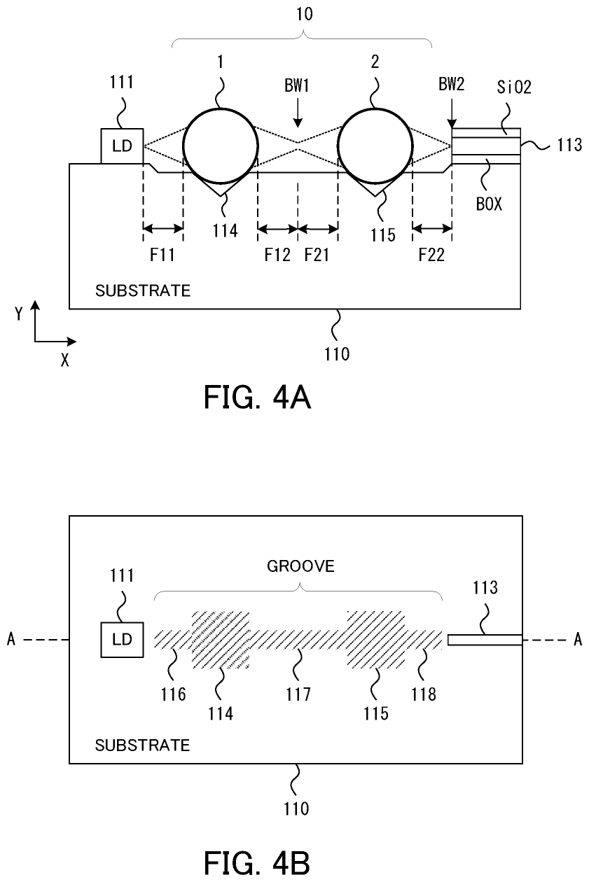

FIGS. 4A and 4B illustrate a first embodiment of the optical device according to the present invention. In the first embodiment, as illustrated in FIG. 4A, the optical device 10 is provided with a ball lens 1 and a ball lens 2. The ball lens 1 corresponds to the first lens circuit 11 illustrated in FIG. 3. In other words, in the first embodiment, the first lens circuit 11 illustrated in FIG. 3 is actualized by the ball lens 1. Further, the ball lens 2 corresponds to the second lens circuit 12 illustrated in FIG. 3. In other words, in the first embodiment, the second lens circuit 12 illustrated in FIG. 3 is actualized by the ball lens 2.

FIG. 4B is a top view of a substrate 110 on which the optical device 10 is mounted. Note that, in FIG. 4B, the lenses 1 and 2 are omitted. FIG. 4A corresponds to section A-A illustrated in FIG. 4B.

The optical device 10 is mounted on the surface of the substrate 110. The substrate 110 is not limited particularly, and for example, is a silicon substrate. The ball lens 1 and the ball lens 2 are mounted respectively using a groove 114 and a groove 115 formed in the surface of the substrate 110. For example, each of the grooves 114 and 115 is actualized by a V groove.

The semiconductor laser light source 111 is mounted on the surface of the substrate 110, and outputs laser light with a specified wavelength. The semiconductor laser light source 111 is one example of the optical output element 21 illustrated in FIG. 3. Further, an optical waveguide 113 is formed on the surface of the substrate 110. In this embodiment, the optical waveguide 113 is formed between an SiO2 layer and a BOX (Buried Oxide) layer. The optical waveguide 113 corresponds to the optical propagation element 22 illustrated in FIG. 3.

In the surface of the substrate 110, the optical device 10 is configured so as to guide laser light generated by the semiconductor laser light source 111 to the optical waveguide 113 by the ball lens 1 and the ball lens 2. Specifically, the laser light generated by the semiconductor laser light source 111 is input to the ball lens 1. Output light of the ball lens 1 is guided to the ball lens 2. Output light of the ball lens 2 is guided to the optical waveguide 113. Herein, it is assumed that heights of an emission end face of the semiconductor laser light source 111 and an end face of the optical waveguide 113 are the same with respect to the surface of the substrate 110. Further, it is designed that an optical axis of the laser light generated by the semiconductor laser light source 111 passes through the center of the ball lens 1 and the center of the ball lens 2.

The laser light generated by the semiconductor laser light source 111 propagates parallel with the surface of the substrate 110. In FIG. 4A, the laser light propagates in the X direction. At this point, when a spacing between the optical axis of the laser light and the surface of the substrate 110 is small, quality of the laser light deteriorates by scattering or reflection on the surface of the substrate 110. Thus, in this embodiment, as illustrated in FIG. 4B, grooves 116, 117, and 118 are formed along a propagation path of the laser light in the surface of the substrate 110. In FIG. 4B, the grooves 114 to 118 are indicated by shaded regions.

Specifically, the groove 116 is formed between a region where the semiconductor laser light source 111 is mounted and a region where the ball lens 1 is mounted. The groove 117 is formed between the region where the ball lens 1 is mounted and a region where the ball lens 2 is mounted. The groove 118 is formed between the region where the ball lens 2 is mounted and the optical waveguide 113. Accordingly, scattering and/or absorption is suppressed in between the semiconductor light laser source 111 and the optical waveguide 113, and it is possible to suppress deterioration of the quality of the laser light.

As explained with reference to FIG. 3, the optical device 10 is configured so as to satisfy “F11=F22” and “F12=F21”. In the first embodiment illustrated in FIGS. 4, F11, F12, F21 and F22 are as described below.

F11 represents an object focal distance of the ball lens 1. The object focal distance indicates a distance between an emission point P of light and a lens. The emission point P (P1 and P2 in FIGS. 2A and 2B) indicates a point from which incident light to the lens is emitted. Accordingly, the emission point P for the ball lens 1 is the semiconductor laser light source 111. Accordingly, the object focal distance F11 indicates a distance between an emission end face of the semiconductor laser light source 111 and the ball lens 1. Note that it is possible to set an arbitrary value as the object focal distance F11. F12 represents an image focal distance of the ball lens 1. The image focal distance indicates a distance between a point in which light emitted from the emission point P is condensed by a lens and the lens. Accordingly, the image focal distance F12 indicates a distance between the ball lens 1 and a beam waist position (hereinafter, beam waist position BW1) of the ball lens 1 for the output light of the semiconductor laser light source 111. The beam waist position BW1 indicates the point at which the output light of the semiconductor laser light source 111 is condensed by the ball lens 1. Note that the image focal distance is determined uniquely with respect to the object focal distance, the shape of the lens and the material (i.e., refractive index) of the lens.

F21 represents an object focal distance of the ball lens 2. Herein, light emitted from the beam waist position BW1 is input to the ball lens 2. In other words, an emission point P for the ball lens 2 is the beam waist position BW1. Accordingly, the object focal distance F21 indicates a distance between the beam waist position BW1 and the ball lens 2. F22 represents an image focal distance of the ball lens 2. The image focal distance F22 indicates a distance between the ball lens 2 and a beam waist position (hereinafter, beam waist position BW2) of the ball lens 2 for the output light of the ball lens 1. The beam waist position BW2 indicates the point at which the output light of the ball lens 1 is condensed by the ball lens 2. Note that, in this embodiment, on the surface of the substrate 110, the end face of the optical waveguide 113 is arranged at the beam waist position BW2.

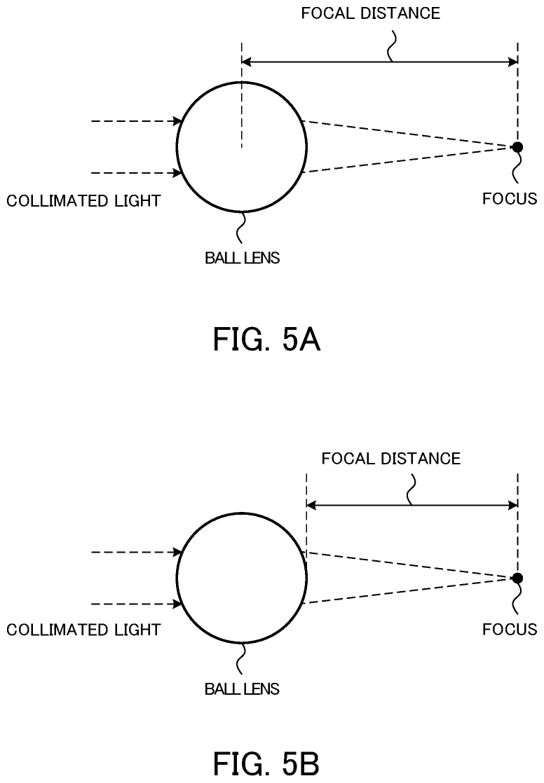

Herein, definitions of the focal distance, object focal distance and image focal distance of a lens will be described. First, FIGS. 5A and 5B are diagrams to explain the definition of the focal distance of a lens. In this example, the focal distance indicates a distance between a point (i.e., focus) at which collimated light incident to a lens is condensed and the lens. Specifically, as illustrated in FIG. 5A, the focal distance indicates the distance between the center of the lens and the focus. However, in the following description, as illustrated in FIG. 5B, the focal distance may refer to a distance between the surface (face from which light passing through the lens is emitted) of the lens and the focus. A distance between the surface of the lens and a condensed point may be called Back Focus (BFL: Back Focal Length). Note that the focal distance illustrated in FIG. 5A is obtained by adding a radius of the ball lens to the focal distance illustrated in FIG. 5B.

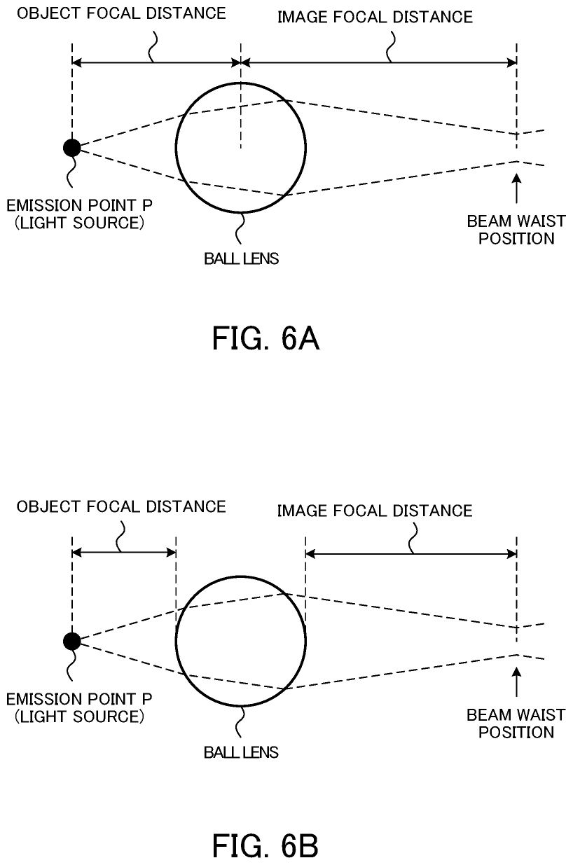

FIGS. 6A and 6B are diagrams to explain the definitions of the object focal distance and image focal distance. The object focal distance indicates a distance between an emission point P of light and a lens. The emission point P indicates a point from which light incident to the lens is emitted. For example, in the optical device 10 illustrated in FIG. 4A, the emission point P for the ball lens 1 is the semiconductor laser light source 111, and the emission point P for the ball lens 2 is the beam waist position BW1. The image focal distance indicates a distance between a point at which light emitted from the emission point P is condensed by the lens and the lens.

In the definition illustrated in FIG. 6A, the object focal distance and image focal distance are configured with the center of the ball lens as reference. In this case, the parameters F11, F12, F21 and F22 representing the configuration of the device 10 are as described below.

The object focal distance F11 indicates the distance between the emission end face of the semiconductor laser light source 111 and the center of the ball lens 1. The image focal distance F12 indicates the distance between the center of the ball lens 1 and the beam waist position BW1 indicative of the point at which the output light of the semiconductor laser light source 111 is condensed by the ball lens 1. The object focal distance F21 indicates the distance between the beam waist position BW1 and the center of the ball lens 2. The image focal distance F22 indicates the distance between the center of the ball lens 2 and the beam waist position BW2 indicative of the point at which the output light of the ball lens 1 is condensed by the ball lens 2.

In the definition illustrated in FIG. 6B, the object focal distance and image focal distance are configured with the surface of the lens as reference. In this case, the parameters F11, F12, F21 and F22 representing the configuration of the device 10 are as described below.

The object focal distance F11 indicates the distance between the emission end face of the semiconductor laser light source 111 and the surface of the ball lens 1 to which the output light of the semiconductor light source 111 is input. The image focal distance F12 indicates the distance between the surface of the ball lens 1 for emitting light propagating from the semiconductor laser light source 111 toward the ball lens 2 and the beam waist position BW1 indicative of the point at which the output light of the semiconductor laser light source 111 is condensed by the ball lens 1. The object focal distance F21 indicates the distance between the beam waist position BW1 and the surface of the ball lens 2 to which the output light of the ball lens 1 is input. The image focal distance F22 indicates the distance between the surface of the ball lens 2 for emitting the light propagating from the ball lens 1 toward the optical waveguide 113 and the beam waist position BW2 indicative of the point at which the output light of the ball lens 1 is condensed by the ball lens 2.

The parameters F11, F12, F21 and F22 representing the configuration of the device 10 may be configured with the definition illustrated in FIG. 6A, or may be configured with the definition illustrated in FIG. 6B. The parameters F11 and F12 configured with the definition illustrated in FIG. 6A are obtained by adding the radius of the ball lens 1 to the parameters F11 and F12 configured with the definition illustrated in FIG. 6B, respectively. Similarly, the parameters F21 and F22 configured with the definition illustrated in FIG. 6A are obtained by adding the radius of the ball lens 2 to the parameters F21 and F22 configured with the definition illustrated in FIG. 6B, respectively.

According to the above-mentioned configuration, the laser light generated by the semiconductor laser light source 111 is guided to the ball lens 2 by the ball lens 1. At this point, the laser light is once condensed in the beam waist position BW1, and subsequently, the mode field diameter is enlarged. Then, the ball lens 2 condenses the laser light to the end face of the optical waveguide 113.

Next, a design example of the optical device 10 will be described. In the following description, it is assumed that the object focal distance and image focal distance are configured with the surface of the ball lens as reference as illustrated in FIG. 6B.

The semiconductor laser light source 111 is mounted face-down on the surface of the substrate 110 so that heights of optical axes of the semiconductor laser light source 111 and the optical waveguide 113 are equal to each other. Specifically, for example, AuSn solder is provided in a specified position of the surface of the substrate 110, the semiconductor laser light source 111 provided with an Au electrode is fixed onto the AuSn solder by flip chip bonding, and the semiconductor laser light source 111 is thereby mounted on the substrate 110. A wavelength of the laser light generated by the semiconductor laser light source 111 is 1.3 μm. By providing a spot size converter on the output side of the semiconductor laser light source 111, a mode field diameter is enlarged to 3 μm. By this means, a mode mismatch is suppressed.

Materials of the ball lenses 1 and 2 are LASF35 having a refractive index of 1.98 with respect to the wavelength of 1.3 μm. Diameters of the ball lenses 1 and 2 are 500 μm. Anti-Reflection (AR) coating is applied to surfaces of the ball lenses 1 and 2.

The distance (i.e., the object focal distance F11 of the ball lens 1) between the emission end face of the semiconductor laser light source 111 and the ball lens 1 is 253 μm. Herein, in the first embodiment, F11=F22 holds. Accordingly, the distance (i.e., the image focal distance F22 of the ball lens 2) between the ball lens 2 and the end face of the optical waveguide 113 is also 253 μm. Further, a spacing (gap width between the lens surface of the ball lens 1 and the lens surface of the ball lens 2) between the ball lens 1 and the ball lens 2 is 506 μm. Herein, in the first embodiment, F12=F21 holds. Accordingly, each of the image focal distance F12 of the ball lens 1 and the object focal distance F21 of the ball lens 2 is 253 μm. When the object focal distance and image focal distance are configured with the center of the ball lens as reference as illustrated in FIG. 6A, F11=F12=F21=F22=503 μm holds.

The ball lenses 1 and/or 2 may not be arranged at desired position on the surface of the substrate 110. For example, due to manufacturing variations, there is the case where depths of the grooves 114 and 115 to hold the ball lenses 1 and 2 deviate from design values. In this case, the optical path to propagate the laser light from the semiconductor laser light source 111 toward the optical waveguide 113 is changed.

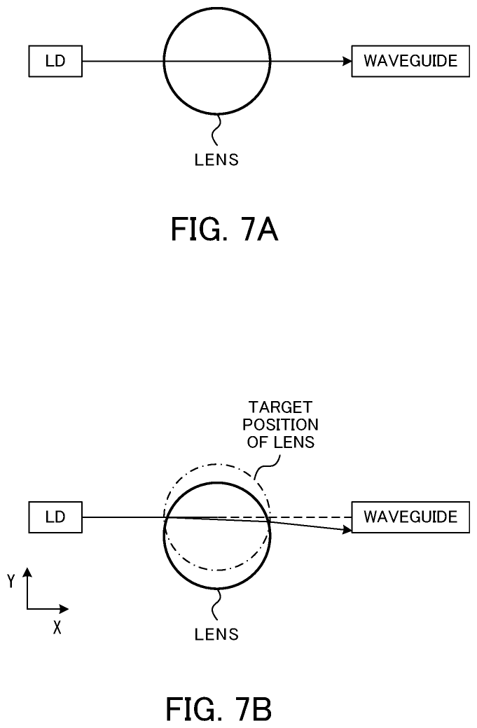

FIGS. 7A and 7B are diagrams to explain an effect by position displacement of the lens. In this example, one ball lens is provided between a light source LD and an optical waveguide. The ball lens guides laser light generated by the light source LD to the optical waveguide. Further, not illustrated in the figure, it is assumed that the ball lens is held by the same groove as the groove 114 or 115 illustrated in FIG. 4A or FIG. 4B. In addition, FIGS. 7A and 7B illustrate optical axes of the laser light propagating from the light source LD to the optical waveguide.

In the case illustrated in FIG. 7A, the ball lens is mounted in a target position with accuracy. In this case, the laser light generated by the light source LD passes through the center of the ball lens, and is guided to a target point (i.e., center of the end face of the optical waveguide).

In the case illustrated in FIG. 7B, the groove to hold the ball lens is deeper than the design value. In this case, a height position of the ball lens is lower than the target position with respect to the optical axis of the laser light generated by the light source LD. In FIG. 7B, the position of the ball lens shifts from the target position in the Y-axis direction. A dashed-line circle illustrated in FIG. 7B indicates the ball lens installed in the target position. When the position of the ball lens shifts, since an incident angle to the ball lens from the light source LD changes, the propagation direction is changed in the laser light generated by the light source LD. As a result, a position of the laser light arriving at the optical waveguide shifts from the target point.

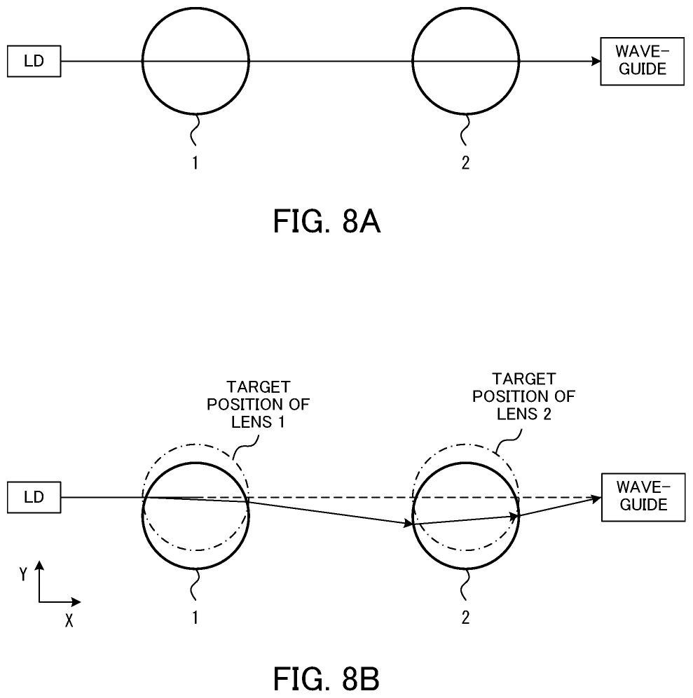

FIGS. 8A and 8B are diagrams to explain a reason why the effect by position displacement of the ball lens is suppressed in the embodiment of the present invention. In this example, as illustrated in FIG. 4A, the ball lenses 1 and 2 configuring the optical device 10 are respectively held by the grooves 114 and 115. In addition, FIGS. 8A and 8B illustrate optical axes of the laser light propagating from the light source LD to the optical waveguide.

In the case illustrated in FIG. 8A, the ball lenses 1 and 2 are mounted in target positions with accuracy, respectively. In this case, the laser light generated by the light source LD is guided to the target point (i.e., center of the end face of the optical waveguide) by the ball lenses 1 and 2.

In the case illustrated in FIG. 8B, the grooves 114 and 115 to hold the ball lenses 1 and 2 are deeper than the design values, respectively. Herein, the grooves 114 and 115 are formed by the same process. Therefore, errors of the depths of the grooves 114 and 115 are the same as each other. In other words, amounts and directions are mutually the same in position displacements of the ball lenses 1 and 2.

When the position of the ball lens 1 shifts, an incident angle from the light source LD to the ball lens 1 is changed. Therefore, with respect to the case where the position displacement of the lens does not occur, the propagation direction changes in the laser light emitted from the ball lens 1. Thus, the incident angle to the ball lens 2 also changes. However, a direction of the change of the incident angle to the ball lens 1 is opposite to a direction of the change of the incident angle to the ball lens 2. Accordingly, the change in the propagation direction occurring when the laser light passes through the ball lens 1 and the change in the propagation direction occurring when the laser light passes through the ball lens 2 are cancelled. In other words, the error of the propagation direction occurring in the ball lens 1 is corrected in the ball lens 2. In addition, the optical device 10 is designed so as to satisfy F11=F22 and F12=F21. Accordingly, the laser light propagating via the ball lens 1 and the ball lens 2 is guided to the target point (i.e., center of the end face of the optical waveguide).

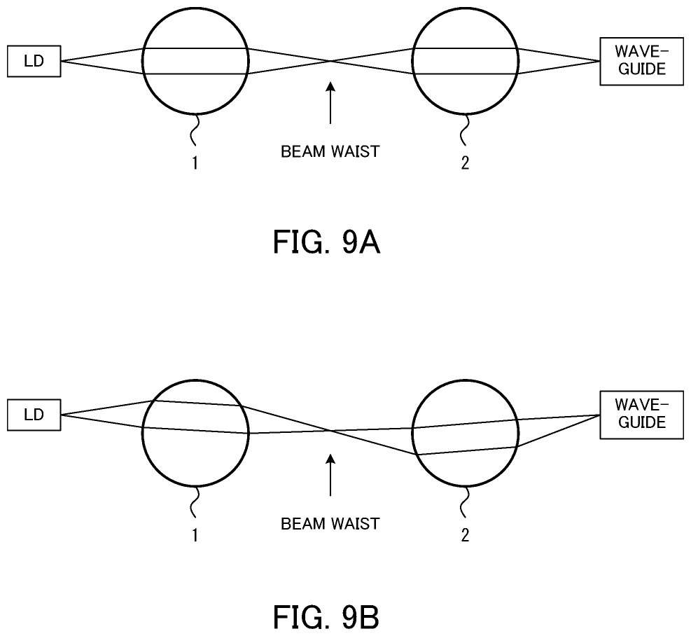

FIGS. 9A and 9B illustrate an example of propagation of the laser light from the light source LD to the optical waveguide. FIGS. 9A and 9B respectively correspond to FIGS. 8A and 8B. In other words, FIG. 9A illustrates propagation of the laser light when the ball lenses 1 and 2 are respectively mounted in the target positions with accuracy. FIG. 9B illustrates propagation of the laser light when the ball lenses 1 and 2 are respectively displaced from the target positions in the direction perpendicular to the surface of the substrate 110. Thus, according to the configuration of the first embodiment of the present invention, even when position displacements of the ball lenses 1 and 2 occur, the laser light propagating via the ball lens 1 and the ball lens 2 is guided to the target point (i.e., center of the end face of the optical waveguide).

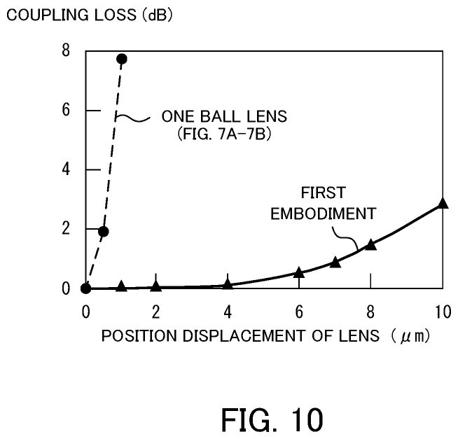

FIG. 10 illustrates an example of the effect by the configuration according to the first embodiment of the present invention. The horizontal axis of the graph represents the displacement of the position of the lens in the direction perpendicular to the surface of the substrate 110. The vertical axis represents the coupling loss between the light source and the optical waveguide.

In the case (i.e., case illustrated in FIGS. 7A and 7B) where one ball lens is provided between the light source LD and the optical waveguide, as illustrated by dashed lines, only by the height position of the ball lens slightly shifting from the target position, a large coupling loss occurs. Specifically, when the height position of the ball lens shifts from the target position by 0.5 μm, the coupling loss of 1.9 dB occurs. Note that the diameter of the ball lens is 500 μm, and the refractive index of the ball lens is 1.98.

In contrast thereto, according to the configuration according to the first embodiment of the present invention, as illustrated by solid lines, even when the height positions of the ball lenses 1 and 2 shift from the target positions, the coupling loss is small. Specifically, the coupling loss is 0.1 dB, when the height positions of the ball lenses 1 and 2 shift from the target positions by 4 μm. Herein, in the case of forming the grooves 114 and 115 by anisotropic etching of the silicon substrate, it is sufficiently possible to control the error of the depth of the groove within 4 μm or less. Note that the diameters of the ball lenses 1 and 2 are 500 μm, and the refractive indexes of the ball lenses 1 and 2 are 1.98. Further, when the object focal distance and image focal distance are configured using the surface of the ball lens as reference, F11, F12, F21 and F22 are 253 μm.

As described above, the optical device 10 according to the first embodiment of the present invention is provided with two ball lenses 1 and 2 between the optical output element (semiconductor laser light source 111, in FIGS. 4A and 4B) and the optical propagation element (optical waveguide 113, in FIGS. 4A and 4B) so as to satisfy F11=F22 and F12=F21. Thus, even when the positions of the ball lenses 1 and 2 are displaced from the target positions in the direction perpendicular to the surface of the substrate 110, the error of the propagation direction of the laser light occurring in the ball lens 1 is corrected in the ball lens 2. Accordingly, even when the lens position may deviate resulting from the manufacturing error of the substrate and the like, it is possible to guide input light to the optical waveguide with a small loss.

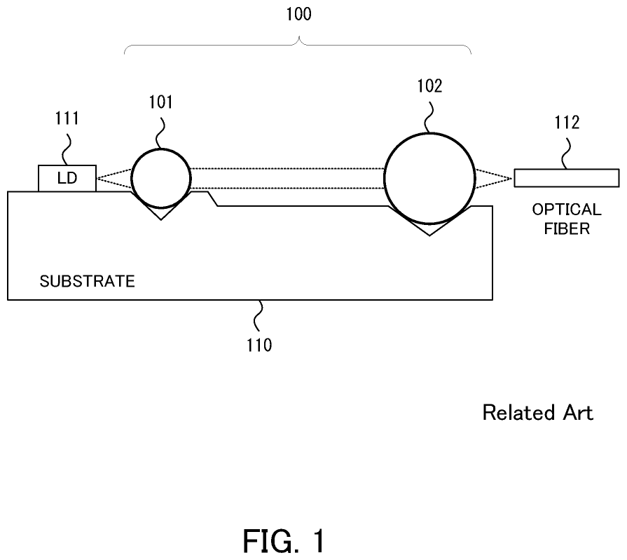

In addition, even in the configuration where the optical device is provided with two ball lenses, in the case of not satisfying F11=F22 and F12=F21, the laser light is not condensed to the target point when the lens position is displaced. For example, in the configuration illustrated in FIG. 1, when the positions of the ball lenses 101 and 102 are displaced from the target positions in the direction perpendicular to the surface of the substrate 110, the ball lens 101 is not able to collimate the input light. As a result, the output light of the ball lens 102 is not condensed to the end face of the optical fiber 112. In other words, the point at which the output light of the ball lens 102 is condensed deviates from the end face of the optical fiber 112.

### Variation of First Embodiment

In the above-mentioned embodiment, with respect to each of the ball lenses 1 and 2, the object focal distance and image focal distance are the same as each other, but the present invention is not limited to this configuration. For example, in the optical device 10 illustrated in FIG. 4A, it may be possible that the object focal distance F11 (i.e., distance from the emission end face of the semiconductor laser light source 111 to the incident face of the ball lens 1) of the ball lens 1 is 361 μm, the image focal distance F12 (i.e., distance from the emission face of the ball lens 1 to the beam waist position BW1) of the ball lens 1 is 180.5 μm, the object focal distance F21 (i.e., distance from the beam waist position BW1 to the incident face of the ball lens 2) of the ball lens 2 is 180.5 μm, and that the image focal distance F22 (i.e., distance from the emission face of the ball lens 2 to the end face of the optical waveguide 113) of the ball lens 2 is 361 μm. In this case, the image is reduced to one half by the ball lens 1, and is enlarged twice by the ball lens 2. Accordingly, the mode field diameter does not change in the laser light input to the optical waveguide 113. Similarly, also in the configuration where the image is enlarged twice by the ball lens 1, and is reduced to one half by the ball lens 2, the mode diameter does not change in the laser light input to the optical waveguide 113. Further, it is possible to arbitrarily determine a ratio between the object focal distance and the image focal distance. In other words, in the case where the product of the magnifying power of the ball lens 1 and the magnifying power of the ball lens 2 is “1”, in any combinations (e.g., “3” and “⅓”), the mode field diameter does not change in the laser light input to the optical waveguide 113.

In the above-mentioned embodiment, the diameters of the ball lenses 1 and 2 are the same as each other, and the materials of the ball lenses 1 and 2 are the same as each other, but the present invention is not limited to this configuration. In other words, as long as F11, F12, F21 and F22 illustrated in FIG. 4A satisfy the above-mentioned relationship, the diameters and materials of the ball lenses 1 and 2 may be changed arbitrarily.

In the above-mentioned embodiment, the ball lens is mounted as each of the first lens circuit 11 and second lens circuit 12, but the present invention is not limited to this configuration. For example, as a substitute for the ball lens, a planoconvex lens may be mounted. In addition, the planoconvex lens may be held using a groove formed by DRIE (Deep Reactive Ion Etching) and the like. Further, in an optical device for coupling a plurality of light sources and a plurality of optical waveguides, by configuring each of the first lens circuit 11 and second lens circuit 12 with an array of planoconvex lenses, it is possible to decrease manufacturing process steps of the optical module.

In the example illustrated in FIG. 4A, the optical device 10 guides the laser light generated by the semiconductor laser light source 111 to the optical waveguide 113, but the present invention is not limited to this configuration. In other words, the optical device 10 may guide laser light generated by a light source to an optical fiber. Further, the optical device 10 may guide light emitted from an end face of an optical waveguide or optical fiber to another optical waveguide or another optical fiber.

In addition, in the case where the optical device 10 guides laser light to an optical fiber, even when a position displacement of a lens occurs, the laser light is guided to the center of the core of the optical fiber with accuracy. Accordingly, without performing aligning of the optical fiber, it is possible to actualize optical transmission with a small coupling loss. As a result, the aligning process of the optical fiber is unnecessary, and manufacturing efficiency is improved in the optical module.

### Second Embodiment

In the first embodiment, each of the first lens circuit 11 and the second lens circuit 12 is provided with one ball lens. In contrast thereto, in the second embodiment, each of the first lens circuit 11 and the second lens circuit 12 is provided with two ball lenses.

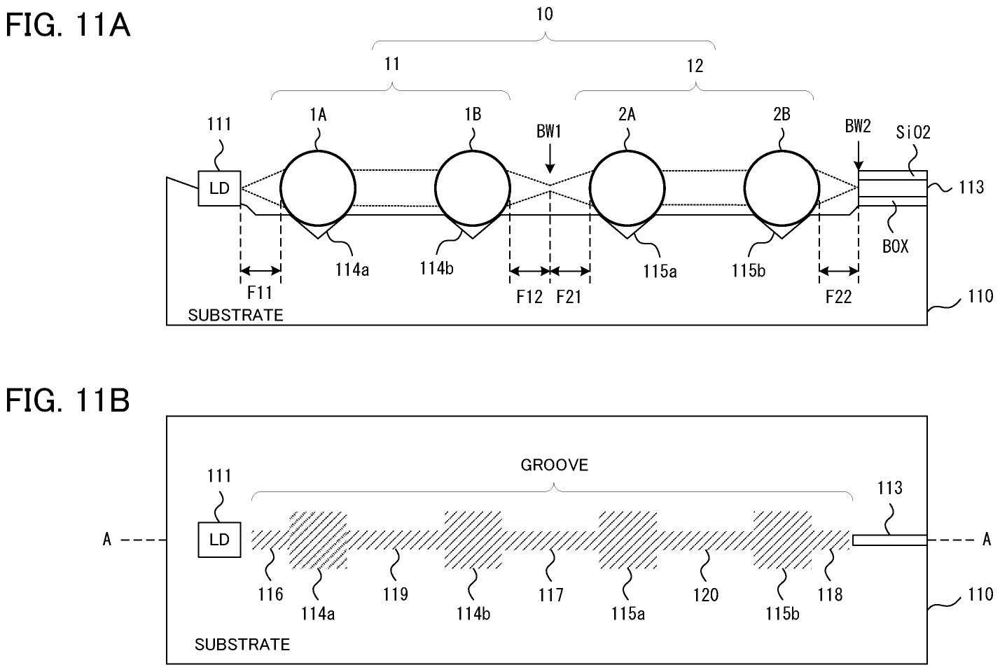

FIGS. 11A and 11B illustrate the second embodiment of the optical device according to the present invention. In the second embodiment, as illustrated in FIG. 11A, the optical device 10 includes ball lenses 1A, 1B, 2A, and 2B. The ball lenses 1A and 1B correspond to the first lens circuit 11 illustrated in FIG. 3, and the ball lenses 2A and 2B correspond to the second lens circuit 12 illustrated in FIG. 3.

FIG. 11B is a top view of the substrate 110 with the optical device 10 mounted. In FIG. 11B, the lenses 1A, 1B, 2A, 2B are omitted. In addition, FIG. 11A corresponds to section A-A illustrated in FIG. 11B.

The ball lenses 1A, 1B, 2A, and 2B are respectively held by grooves 114a, 114b, 115a, and 115b. Each of the grooves 114a, 114b, 115a, and 115b is a V groove formed in the surface of the substrate 110. As illustrated in FIG. 11B, grooves 116-120 are further formed in the surface of the substrate 110. The grooves 116-118 are substantially the same in the FIG. 4B and FIG. 11B. The groove 119 is formed along a propagation path of light between the ball lenses 1A and 1B, and the groove 120 is formed along a propagation path of light between the ball lenses 2A and 2B.

In the surface of the substrate 110 with the optical device 10 mounted, the grooves 116-120 are formed along an optical path between the semiconductor laser light source 111 and the optical waveguide 113. Accordingly, scattering and/or absorption is suppressed in between the semiconductor laser light source 111 and the optical waveguide 113, and it is possible to suppress deterioration of the quality of the laser light.

In the optical device 10 with the above-mentioned configuration, the laser light generated by the semiconductor laser light source 111 passes through the ball lens 1A, the ball lens 1B, the ball lens 2A and the ball lens 2B, and is guided to the optical waveguide 113. Specifically, the ball lens 1A guides the laser light generated by the semiconductor laser light source 111 to the ball lens 1B. The ball lens 1B guides output light of the ball lens 1A to the ball lens 2A. The ball lens 2A guides output light of the ball lens 1B to the ball lens 2B. The ball lens 2B guides output light of the ball lens 2A to the optical waveguide 113. Herein, the optical device 10 is designed so that the optical axis of the laser light propagating from the semiconductor laser light source 111 to the optical waveguide 113 passes through the center of each of the ball lenses 1A, 1B, 2A, and 2B. In addition, due to manufacturing errors and the like, it sometimes occurs that positions of the ball lenses 1A, 1B, 2A, and 2B are displaced from target positions in the direction perpendicular to the surface of the substrate 110.

Shapes and materials of the ball lenses 1A, 1B, 2A, and 2B are mutually the same. In other words, focal distances f of the ball lenses 1A, 1B, 2A, and 2B are the same as each other. For example, the focal distance f of each of the ball lenses 1A, 1B, 2A, and 2B is 2.7 μm. In this example, as illustrated in FIG. 5B, the focal distance f indicates a distance between a point in which collimated light incident to the ball lens is condensed and the surface of the ball lens.

In the second embodiment, as illustrated in FIG. 11A, the object focal distance F11 of the first lens circuit 11 indicates the distance between the emission end face of the semiconductor laser light source 111 and the ball lens 1A. The image focal distance F12 of the first lens circuit 11 indicates the distance between the ball lens 1B and the beam waist position BW1. The beam waist position BW1 indicates the point at which output light of the ball lens 1B is condensed. The object focal distance F21 of the second lens circuit 12 indicates the distance between the beam waist position BW1 and the ball lens 2A. The image focal distance F22 of the second lens circuit 12 indicates the distance between the ball lens 2B and the beam waist position BW2. The beam waist position BW2 indicates the point at which the output light of the ball lens 2B is condensed.

The optical device 10 is designed so as to satisfy F11=F22 and F12=F21. Specifically, when the focal distance of the ball lens 1A is f1a, the focal distance of the ball lens 1B is f1b, the focal distance of the ball lens 2A is f2a, and the focal distance of the ball lens 2B is f2b, the optical device 10 is designed so as to satisfy F11=f1a, F12+F21=f1b+f2a, F22=f2b, f1a=f2b and f1b=f2a. In this embodiment, the focal distances (f1a, f1b, f2a, and f2b) of the ball lenses 1A, 1B, 2A, and 2B are the same as each other, and the above-mentioned condition is satisfied.

In this case, the laser light generated by the semiconductor laser light source 111 is collimated by the ball lens 1A. In other words, the collimated light propagates from the ball lens 1A to the ball lens 1B. A spacing between the ball lenses 1A and 1B is not limited particularly, and may be 100 μm. Then, the ball lens 1B guides input light to the ball lens 2A.

A spacing between the ball lenses 1B and 2A is F12+F21, and is the sum of the focal distance of the ball lens 1B and the focal distance of the ball lens 2A. In other words, the spacing between the ball lenses 1B and 2A is 5.4 μm. Then, output light of the ball lens 1B is condensed in the beam waist position BW1, and then, is input to the ball lens 2A, while enlarging the mode field diameter. Accordingly, the collimated light propagates from the ball lens 2A to the ball lens 2B. A spacing between the ball lenses 2A and 2B is not limited particularly, and may be 100 μm. Then, the ball lens 2B guides input light to the optical waveguide 113.

In the above-mentioned configuration, when the positions of the ball lenses 1A, 1B, 2A, and 2B deviate from the target positions in the direction perpendicular to the surface of the substrate 110, the propagation path of the laser light generated by the semiconductor laser light source 111 is changed. However, an error of the propagating path occurring in the first lens circuit 11 is corrected in the second lens circuit 12. Accordingly, even when the positions of the ball lenses 1A, 1B, 2A, and 2B deviate from the target positions, the laser light is condensed in the target point in the end face of the optical waveguide 113.

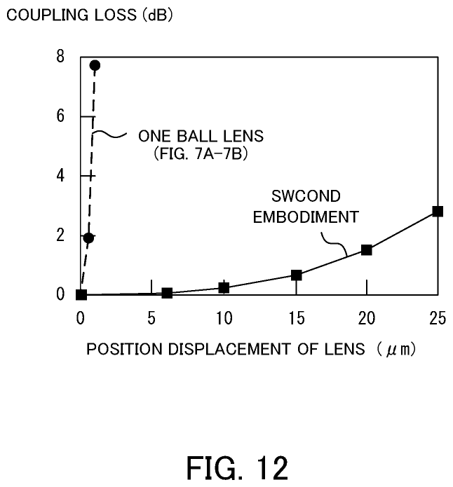

FIG. 12 illustrates an example of an effect by the configuration according to the second embodiment of the present invention. The case (i.e., case illustrated in FIGS. 7A and 7B) where one ball lens is provided between the light source LD and the optical waveguide is the same in FIGS. 10 and 12.

According to the configuration according to the second embodiment of the present invention, as illustrated by solid lines, even when height positions of the ball lenses 1A, 1B, 2A, and 2B shift from the target positions, the coupling loss is small. Specifically, the coupling loss is 0.2 dB when the height positions of the ball lenses shift from the target positions by 10 μm. In other words, according to the configuration of the second embodiment, as compared with the first embodiment, tolerance to misalignment of lenses is further increased.

### Third Embodiment

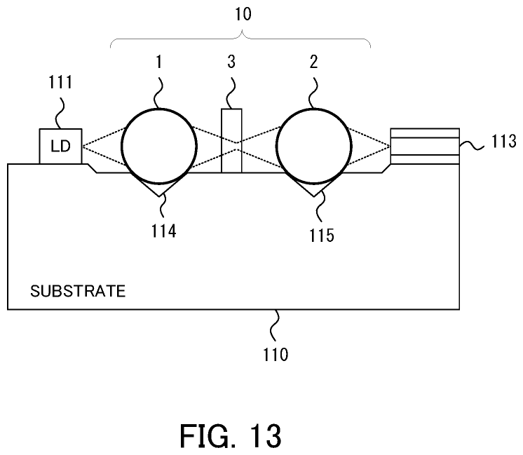

FIG. 13 illustrates a third embodiment of the optical device according the present invention. In addition to the configuration illustrated in FIG. 4A, the optical device 10 according to the third embodiment is provided with an optical isolator 3. A surface of the optical isolator 3 is applied with AR coating. The optical isolator 3 is provided in an arbitrary position between the semiconductor laser light source 111 and the optical waveguide 113. In the embodiment illustrated in FIG. 13, the optical isolator 3 is mounted between the ball lens 1 and the ball lens 2. According to this configuration, it is possible to suppress optical noise components returning from the optical device 10 to the semiconductor laser light source 111. Accordingly, operation of the semiconductor laser light source 111 is stabilized.

### Fourth Embodiment

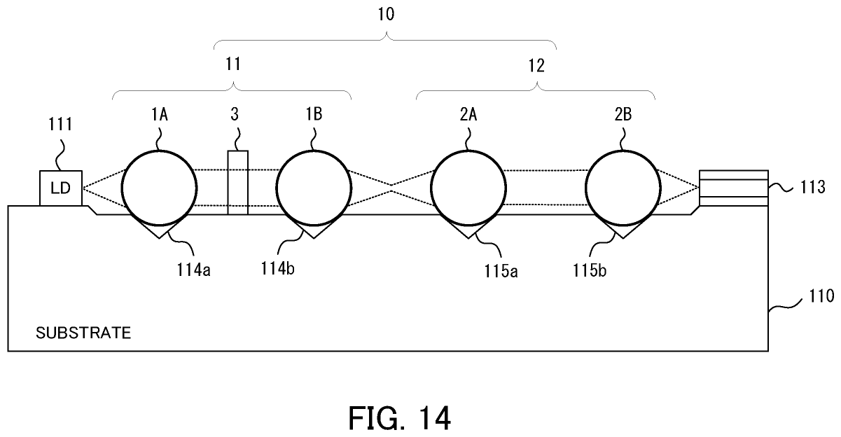

FIG. 14 illustrates a fourth embodiment of the optical device according to the present invention. In addition to the configuration illustrated in FIG. 11A, the optical device 10 according to the fourth embodiment is provided with the optical isolator 3. The surface of the optical isolator 3 is applied with AR coating. The optical isolator 3 is provided in an arbitrary position between the semiconductor laser light source 111 and the optical waveguide 113. In the embodiment illustrated in FIG. 14, the optical isolator 3 is mounted between the ball lens 1A and the ball lens 1B. According to this configuration, it is possible to suppress optical noise components returning from the optical device 10 to the semiconductor laser light source 111. Accordingly, operation of the semiconductor laser light source 111 is stabilized.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An optical device provided between an optical output element and an optical propagation element, the optical device comprising:
a first lens circuit configured to include one or more lenses through which output light of the optical output element passes; and
a second lens circuit configured to include one or more lenses and guide output light of the first lens circuit to the optical propagation element, wherein
when F11 represents a distance between the optical output element and the first lens circuit,
F12 represents a distance between the first lens circuit and a first beam waist position indicative of a point at which the output light of the optical output element is condensed by the first lens circuit,
F21 represents a distance between the first beam waist position and the second lens circuit, and
F22 represents a distance between the second lens circuit and a second beam waist position indicative of a point at which the output light of the first lens circuit is condensed by the second lens circuit,
F11 and F22 are equal to each other and F12 and F21 are equal to each other.

2. The optical device according to claim 1, wherein
the first lens circuit is comprised of a first lens, and the second lens circuit is comprised of a second lens.

3. The optical device according to claim 2, wherein
a shape and a material of the first lens are the same as a shape and a material of the second lens.

4. The optical device according to claim 3, wherein
each of the first lens and the second lens is a ball lens or a planoconvex lens.

5. The optical device according to claim 2, wherein
the first lens and the second lens are respectively held in grooves formed in a surface of a substrate on which the optical device is mounted.

6. The optical device according to claim 1, wherein
the first lens circuit includes a first lens and a second lens,
the second lens circuit includes a third lens and a fourth lens,
the first lens guides the output light of the optical output element to the second lens,
the second lens guides output light of the first lens to the third lens,
the third lens guides output light of the second lens to the fourth lens,
the fourth lens guides output light of the third lens to the optical propagation element, and
when a focal distance of the first lens is f1, a focal distance of the second lens is f2, a focal distance of the third lens is f3, and a focal distance of the fourth lens is f4, F11=f1, F12+F21=f2+f3, F22=f4, f1=f4 and f2=f3 are satisfied.

7. The optical device according to claim 1, wherein
the optical output element is a light source, an optical waveguide or an optical fiber, and
the optical propagation element is an optical waveguide or an optical fiber.

8. The optical device according to claim 1, further comprising:
an optical isolator provided between the optical output element and the optical propagation element.

9. The optical device according to claim 1, wherein
a groove is formed along an optical path between the optical output element and the optical propagation element in a surface of a substrate on which the optical device is mounted.
